(19) United States
(12) Patent Application Publication
(10) Pub. No.: US 2025/0014364 A1
(43) Pub. Date: Jan. 9, 2025

(54) WORK SUPPORT SYSTEM, AND WORK TARGET SPECIFYING DEVICE AND METHOD

(71) Applicant: Hitachi, Ltd., Chiyoda-ku, Tokyo (JP)

(72) Inventor: Takayuki FUJIWARA, Tokyo (JP)

(21) Appl. No.: 18/712,419

(22) PCT Filed: Nov. 24, 2022
(86) PCT No.: PCT/JP2022/043394

§ 371 Date: May 22, 2024

(30) Foreign Application Priority Data
Dec. 3, 2021 (JP) 2021-196938

(51) Int. Cl. G06V 20/64; G06Q 10/0631

(52) U.S. Cl. CPC G06V 20/647; G06Q 10/063114

(57) ABSTRACT

Provided are a work support system and a work target specifying device and method capable of improving usability. A work support system 7 for supporting work of a worker includes: a work target specifying device 1 to be used by the worker U1; and a work support device 2 to be used by a work supporter U2 for supporting the work of the worker, the work support device being communicably connected to the work target specifying device. The work target specifying device is configured to acquire three-dimensional space data 52 of a work space including a target device, create predetermined image data by associating two-dimensional image data 51 obtained by imaging the target device with the target device in the three-dimensional space data, and output the created predetermined image data to the work support device. The work support device is configured to display the predetermined image data received from the work target specifying device, and transmit information received from the work supporter to the work target specifying device.

### TECHNICAL FIELD

The present invention relates to a work support system, and a work target specifying device and method.

### BACKGROUND ART

Various devices such as a switchboard, a control panel, and a server are disposed in various facilities such as a factory, a power plant, and a server room. When maintenance and inspection of these devices are performed, a worker performs maintenance and inspection work according to contents described in a work instruction. When a worker has little experience and is difficult to work by one person, a skilled worker may proceed with maintenance and inspection work while guiding on the site. However, when the skilled worker needs to teach a plurality of unskilled workers, it is difficult for the skilled worker to go to the site together with the unskilled workers due to time restrictions.

There is known a technique in which a skilled worker supports an on-site worker from a remote location (PTL 1). In the related art, for example, an on-site worker wears a wearable device and continuously transmits images captured by the wearable device to a remote skilled worker. The remote device on the skilled worker side creates and displays an on-site image in which images received from the on-site wearable device are connected to one image. The skilled worker selects a work target portion on the connected image. The wearable device of the worker is notified that the skilled worker moves from a remote location to the vicinity of the image of the designated work target portion.

In another related art, features of a work site are acquired as a point group and registered in advance. When a worker performs work, a device used by the worker three-dimensionally indicates a work target portion by aligning the point group based on coordinates during registration (PTL 2).

### CITATION LIST

### Patent Literature

PTL 1: JP2016-181751A
PTL 2: JP2019-159668A

### SUMMARY OF INVENTION

### Technical Problem

In the technique described in PTL 1, since the work site is reproduced only by a two-dimensional image, it is difficult for the skilled worker to intuitively grasp a position of a work target by viewing the two-dimensional image. In the technique of PTL 1, since it is particularly difficult to grasp a depth, it is difficult to specify the work target at a place where shelves, pipes, and devices are complicated.

In the technique of PTL 2, it is necessary to perform processing of acquiring a three-dimensional space of the work site as point group data and allocating the point group data to a three-dimensional map before starting work. Accordingly, it is not possible to quickly cope with a new work site, and it is difficult to use. Further, when a situation of the work site changes, since the acquired point group data cannot be used as it is, it is not possible to quickly cope with the situation change of the work site.

The invention has been made in view of the above problems, and an object of the invention is to provide a work support system and a work target specifying device and method capable of improving usability.

### Solution to Problem

In order to solve the above problem, a work support system according to one aspect of the invention is a work support system for supporting work of a worker. The work support system includes: a work target specifying device to be used by the worker; and a work support device to be used by a work supporter for supporting the work of the worker, the work support device being communicably connected to the work target specifying device. The work target specifying device is configured to acquire three-dimensional space data of a work space including a target device, create predetermined image data by associating two-dimensional image data obtained by imaging the target device with the target device in the three-dimensional space data, and output the created predetermined image data to the work support device. The work support device is configured to display the predetermined image data received from the work target specifying device, and transmit information received from the work supporter to the work target specifying device.

### Advantageous Effects of Invention

According to the invention, a target device at a work site can be specified.

### BRIEF DESCRIPTION OF DRAWINGS

FIG. 1 is an overall schematic diagram of a work support system.

FIG. 2 is a block diagram of a work target specifying device.

FIG. 3 is a configuration diagram of the work target specifying device.

FIG. 4 is a configuration diagram of a work support device.

FIG. 5 is a diagram showing a method of generating a support content.

FIG. 6 is a flowchart of work target specifying processing.

FIG. 7 is a flowchart of work support processing.

FIG. 8 is a diagram showing an example of the support content.

FIG. 9 is a diagram showing a screen of an object recognition result.

FIG. 10 is a diagram showing a screen when a plurality of candidates are detected.

FIG. 11 is a diagram showing an example of a screen in which two-dimensional image data of a target device is associated with the target device in three-dimensional space data.

FIG. 12 is a diagram showing a state in which predetermined image data acquired from the work target specifying device is operated on the screen of the work support device.

FIG. 13 is a flowchart showing processing of the work support device.

FIG. 14 is a flowchart of processing of evaluating work according to a second embodiment.

FIG. 15 is an overall schematic diagram of a work support system according to a third embodiment.

### DESCRIPTION OF EMBODIMENTS

Hereinafter, embodiments of the invention will be described with reference to the drawings. In the embodiment, a work support system that specifies a work target device at a work site will be described. By a work support system 4 according to the embodiment, a work supporter at a distant place can intuitively understand a work situation of the work target device by a worker U1. The work situation remotely grasped by a work supporter includes a position confirmation as to whether a worker is going to perform work for a target device designated in advance.

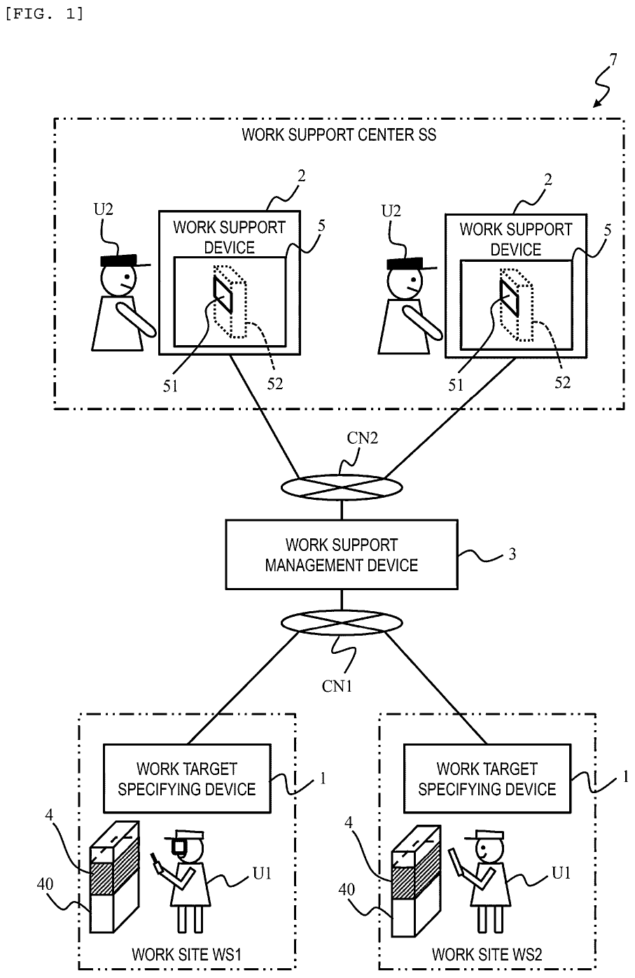

As will be described with reference to FIGS. 1 to 11, a work support system 7 according to the embodiment includes: a space grasping program (space grasping unit 111) that creates three-dimensional space data; a work instruction manual management database 122 that manages a work instruction manual; a work instruction manual analysis program (work instruction manual analysis unit 112) that analyzes a work instruction manual 140; a support content control program (support content control unit 114) that displays a support content 150 of a work instruction based on the analyzed work instruction manual; an imaging unit (2D camera 131) that images a work situation; an object recognition program (object recognition unit 113) that recognizes an object included in an imaging result; and a portion determination program (portion determination unit 115) that displays the work instruction and an object recognition processing result, creates space data of a work site based on the created three-dimensional space data, displays candidates of the work target device based on identification information of the work target device 4 included in the work instruction manual, and associates a place of the work target device selected from the displayed candidates with the three-dimensional space data. Hereinafter, the work target device 4 is also referred to as a target device 4.

According to the work support system 7 of the embodiment, it is not necessary to collect three-dimensional space data in a work site WS in advance, and even when the work site WS is dynamically changed, a remote supporter U2 (supervisor) can easily grasp a three-dimensional position of the target device 4 of the worker U1.

In the embodiment, as described later, when there are a plurality of identification information candidates of the target device 4 included in the work instruction manual 140, the object recognition program displays a message for selecting the target device. When the number of identification information candidates is one, the object recognition program can prompt the worker U1 to perform only confirmation.

When the object recognition program cannot specify the target device 4, the worker U1 may be requested to input information for specifying the target device 4.

The object recognition program can cause an output unit 134 of a work target specifying device 1 to display the information of the target device 4 to be recognized, by analyzing a voice or a captured image received from the worker U1.

### First Embodiment

A first embodiment will be described with reference to FIGS. 1 to 13. In the first embodiment, an example will be described in which, after the worker U1 provides the target device 4, arrives at the work site WS, and specifies a portion to perform work, the remote work supporter U2 performs double confirmation for the specific portion. Hereinafter, the work supporter U2 may be referred to as a skilled worker U2.

The work according to the embodiment means work including manual work for the device 4. For example, the work according to the embodiment is maintenance work such as inspection of components, replacement of components, and update of software. The work support system 7 according to the embodiment is applicable to various devices 4 provided in various work sites WS such as a factory, a power plant, a commercial facility, a hotel, and an airport. Examples of the various devices 4 include an air conditioner, a copier, a server, a network device, a motor, a control panel, a switchboard, and a machine tool. Hereinafter, the maintenance work of the server will be described as an example.

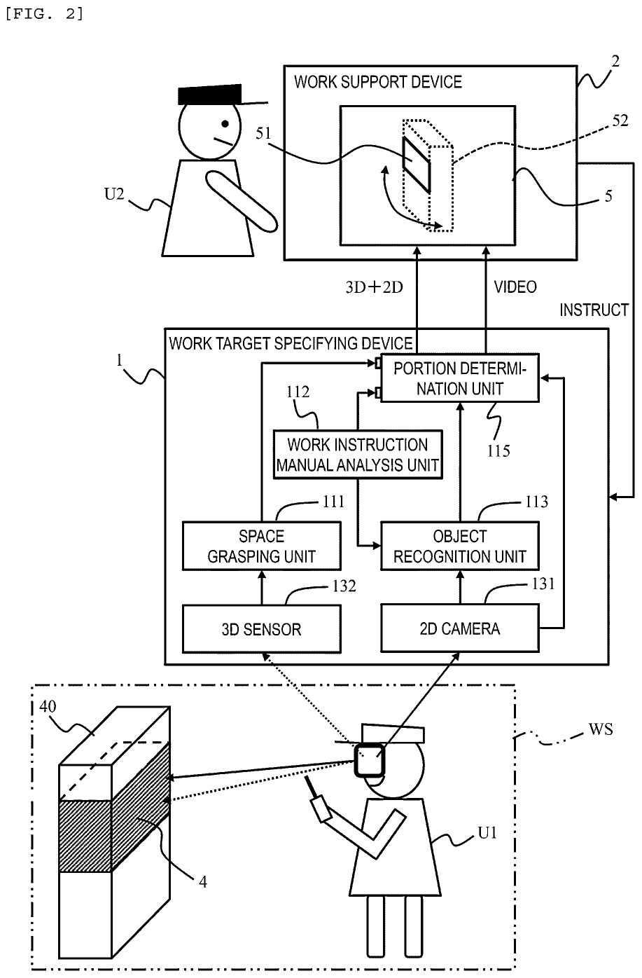

FIG. 1 is an overall schematic diagram of the work support system 7. FIG. 2 is a block diagram of the work target specifying device 1.

The work support system 7 includes, for example, at least one work target specifying device 1 and at least one work support device 2. The work target specifying device 1 and the work support device 2 are connected via communication networks CN1 and CN2 in a bidirectional communication manner.

A work support management device 3 may be provided between the work target specifying device 1 and the work support device 2. The work support management device 3 can acquire information such as three-dimensional space data and two-dimensional image data from the work target specifying device 1, and transmit an analysis result or a processing result of the acquired information to the work support device 2. The work support management device 3 can have a function of the work target specifying device 1 described in FIG. 2. The work support management device 3 may be disposed in a work support center SS as a so-called on-premise server. The work support management device 3 may be provided on a communication network as a so-called cloud service.

As in other embodiments described later, the work target specifying device 1 and the work support management device 3 can be directly connected. In this case, at least a part of the functions of the work target specifying device 1 may be provided in the work support device 2, and only the two-dimensional image data and the three-dimensional space data may be transmitted from the work target specifying device 1 to the work support device 2.

The work target specifying device 1 and the work support device 2 may be connected to each other in a one-to-one relationship, or may be connected to each other in a one-to-many relationship, in a many-to-one relationship, or in a many-to-many relationship. One work support device 2 may be connected to one work target specifying device 1, and one skilled worker U2 may guide and supervise one worker U1. One work support device 2 may be connected to a plurality of work target specifying devices 1, and one skilled worker U2 may guide and supervise a plurality of workers U1. A plurality of work support devices 2 may be connected to one work target specifying device 1, and a plurality of skilled workers U2 may guide and supervise one worker U1. The plurality of work support devices 2 may be connected to the plurality of work target specifying devices 1, and the plurality of skilled workers U2 may manage, guide, and supervise the plurality of workers U1 in a group. That is, a group including the plurality of skilled workers U2 can remotely guide and supervise a group including the plurality of workers U1.

When the worker U1 arrives at the work site WS, the worker U1 finds the device 4 as a work target from various devices provided in the work site WS, and performs predetermined work on the target device 4. The worker U1 finds the target device 4 in the work site WS by using the work target specifying device 1, generates predetermined image data by associating the three-dimensional space data including the target device 4 with the two-dimensional image data obtained by imaging the target device 4, and transmits the generated predetermined image data to the work support device 2.

The work target specifying device 1 is implemented by, for example, a tablet computer, a smartphone, a glasses-type wearable terminal, or the like. That is, the work target specifying device 1 is a device having a calculation function, a communication function, a memory function, a function of capturing a two-dimensional image, and a function of acquiring the three-dimensional space data, and may be portable and may have any name.

The work support center SS is provided with the work support device 2. When the predetermined image data is received from the work target specifying device 1 of the work site WS, the work support device 2 displays the predetermined image data on a monitor display. The work supporter U2 can confirm that the worker U1 has arrived at the place of the target device 4 by viewing a predetermined image 5 displayed on the work support device 2. The image 5 displayed on the work support device 2 is created based on the predetermined image data and is displayed. In the image 5, two-dimensional image data 51 corresponding to the target device 4, two-dimensional image data (here, not shown) of a part of a periphery configuration 40 existing in the periphery of the target device 4, and three-dimensional space data 52 on the periphery including the target device 4 are associated with one another. Since the two-dimensional image data 51 is associated with the three-dimensional space data 52, the work supporter U2 can confirm the two-dimensional image data of the target device 4 from a plurality of angles, for example, by rotating the three-dimensional space data 52.

An operation of the work target specifying device 1 will be described with reference to FIG. 2. The work target specifying device 1 shown in FIG. 2 is implemented by a glasses-type wearable terminal. When the worker U1 arrives at the work site WS, the worker U1 scans the surrounding space with a three-dimensional sensor 132 serving as a “three-dimensional space data acquisition unit” to acquire scan data (point group data). The space grasping unit 111 grasps the scanned space based on the data acquired by the three-dimensional sensor 132. The grasping of the scanned space by the space grasping unit 111 means obtaining of data indicating a structure of the scanned space.

When the worker U1 finds the target device 4, the worker U1 images the target device 4 using the 2D camera 131 as a “two-dimensional image data acquisition unit”. The object recognition unit 113 recognizes the imaged target device 4. For example, the object recognition unit 113 determines whether an object shown in the two-dimensional image data is the target device 4 by comparing device identification information such as a product name and/or a model name printed or attached to the target device 4 with device identification information described in the work instruction manual.

The portion determination unit 115 has a function of determining a device or a part of the device when the worker U1 is to work or during work. In other words, the portion determination unit 115 specifies a work position such as a portion where the worker U1 works. The portion determination unit 115 associates the two-dimensional image data of the recognized target device 4 with the three-dimensional space data of the periphery configuration 40 of the target device 4 to generate composite image data as the “predetermined image data”. The portion determination unit 115 transmits the generated composite image data to the work support device 2.

When the composite image data is received from the work target specifying device 1, the work support device 2 displays the composite image 5 on the monitor display. The composite image 5 includes the two-dimensional image 51 corresponding to the target device 4 and the three-dimensional image 52 corresponding to the peripheral configuration 40 of the target device 4. For example, when the target device 4 is a server, the periphery configuration 40 is a rack or the like. The work supporter U2 operates and rotates the three-dimensional image 52 (three-dimensional space data), so that the two-dimensional image 51 can also be confirmed while being rotated together.

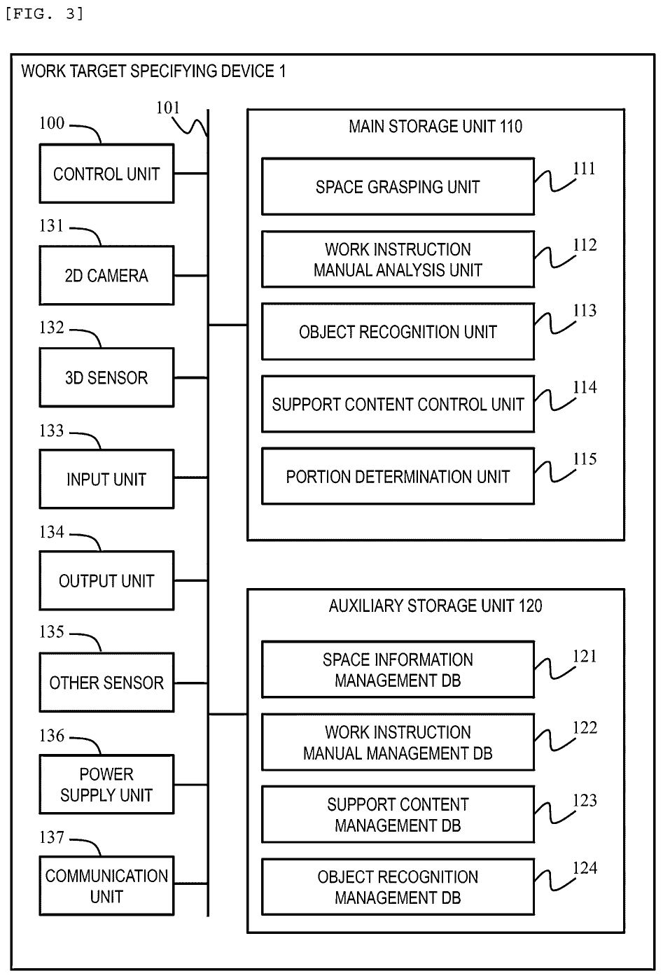

A configuration of the work target specifying device 1 will be described with reference to FIG. 3. The work target specifying device 1 is a device used when the worker U1 performs the maintenance work, and has a function of specifying the work target device 4, confirming a work procedure, and registering a work result. The maintenance work referred to in the present specification also includes inspection work or the like.

As described above, the work target specifying device 1 is, for example, a computer device such as a personal computer, a smartphone, a tablet terminal, or a head-mounted display, and includes a display device such as a liquid crystal display, and input devices such as a keyboard, a mouse, a touch panel, a touch pen, a touch sensor, voice recognition, line-of-sight recognition, and hand recognition.

The work target specifying device 1 includes, for example, a control unit 100, a main storage unit 110, an auxiliary storage unit 120, the 2D camera 131, a 3D sensor 132, an input unit 133, the output unit 134, another sensor 135, a power supply unit 136, and a communication unit 137. The electronic circuits 100, 110, 120, and 131 to 137 are connected via a bus 101.

The control unit 100 controls the operation of the work target specifying device 1. The control unit 100 includes, for example, a microprocessor, a cache memory, and a graphics processing unit (GPU). The control unit 100 reads and executes the computer programs 111 to 115 stored in the main storage unit 110.

The main storage unit 110 is implemented by, for example, a dynamic random access memory (DRAM). The main storage unit 110 stores the computer programs such as the space grasping unit 111, the work instruction manual analysis unit 112, the object recognition unit 113, the support content control unit 114, and the portion determination unit 115. The computer programs 111 to 115 may be read from the auxiliary storage unit 120 to the main storage unit 110 and loaded.

The auxiliary storage unit 120 includes a recording medium built in the work target specifying device 1, a removable external recording medium, an optical disk, or the like. The auxiliary storage unit 120 stores various types of data such as a space information management database 121, the work instruction manual management database 122, a support content management database 123, and an object recognition management database 124. The databases 121 to 124 are appropriately used and updated by the computer programs 111 to 115.

The 2D camera 131 includes, for example, an optical lens, an imaging element, a signal processing circuit, or the like, and images the target device 4 or the component thereof according to an operation of the worker U1. The captured two-dimensional image data is stored in the object recognition management database 124.

The 3D sensor 132 is, for example, a time of flight (ToF) sensor or a stereo camera, and acquires three-dimensional space data. The three-dimensional space data acquired by the 3D sensor 132 is stored in the space information management database 121.

The input unit 133 is a device through which the worker U1 inputs information to the work target specifying device 1. As the input unit 133, for example, a keyboard, a touch panel, a mouse, a touch pen, a touch sensor, a microphone, a voice recognition device, a line-of-sight recognition device, a device that recognizes an operation of a hand, or a combination thereof can be used.

The output unit 134 is a device that outputs information from the work target specifying device 1 to the worker U1. As the output unit 134, for example, a display device such as a liquid crystal display or an organic electroluminescence display (organic EL display), a speaker, a printer, or a combination thereof can be used.

The display serving as the output unit 134 displays, for example, a work instruction content and a place of the work target device 4. The instruction from the work supporter U2 may be displayed on the display as characters or may be output from the speaker as voice. The work instruction content, the place of the work target device 4, advice from the work supporter U2, or the like may be printed by the printer. The printer may be built in the work target specifying device 1, or may be connected via a wireless or wired communication network.

The other sensor 135 is, for example, an illuminance sensor, an acceleration sensor, a ground magnetic sensor, a pressure sensor, a temperature sensor, or a combination thereof. The other sensor 135 senses a result corresponding to the operation of the worker U1 who uses the work target specifying device 1. The other sensor 135 does not need to be built in the work target specifying device 1, and may be connected to the work target specifying device 1 via a wireless or wired communication network. For example, the other sensor 135 may be provided in an arm clock-type terminal worn by the worker U1, and the detected sensing data may be transmitted to the work target specifying device 1 implemented by a glasses-type terminal. The other sensor 135 may include a sensor that detects a vital sign, such as a pulse sensor or a blood pressure sensor. The work supporter U2 can more appropriately grasp the situation of the worker U1 by transmitting the vital sign and the work content of the worker U1 to the work support device 2.

The power supply unit 136 is a device that supplies power to portions requiring power supply among the units of the work target specifying device 1. The power supply unit 136 is implemented by, for example, a battery, an AC-DC conversion adapter, and a charging circuit. The power supply unit 136 may obtain power wirelessly from a wireless power supply device (not shown).

The communication unit 137 is a device that communicates with the work support device 2 via the communication networks CN1 and CN2.

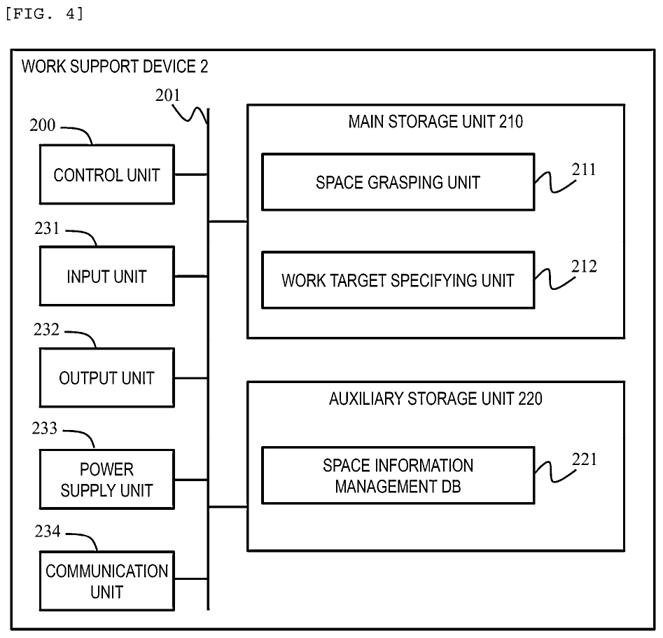

A schematic configuration of the work support device 2 will be described with reference to FIG. 4. As shown in FIG. 4, the work support device 2 includes, for example, a control unit 200, a main storage unit 210, an auxiliary storage unit 220, an input unit 231, an output unit 232, a power supply unit 233, and a communication unit 234. The electronic circuits 200, 210, 220, and 231 to 234 are connected via a bus 201.

The control unit 200 controls an operation of the work support device 2. The control unit 200 reads and executes computer programs 211 and 212 stored in the main storage unit 210.

The main storage unit 210 stores the computer programs such as the space grasping unit 211 and the work target specifying unit 212. The computer programs 211 and 212 may be read from the auxiliary storage unit 220 to the main storage unit 210 and loaded. The auxiliary storage unit 220 stores a space information management database 221. The power supply unit 233 supplies power to the units requiring power. The communication unit 234 communicates with the work target specifying device 1 via the communication networks CN1 and CN2.

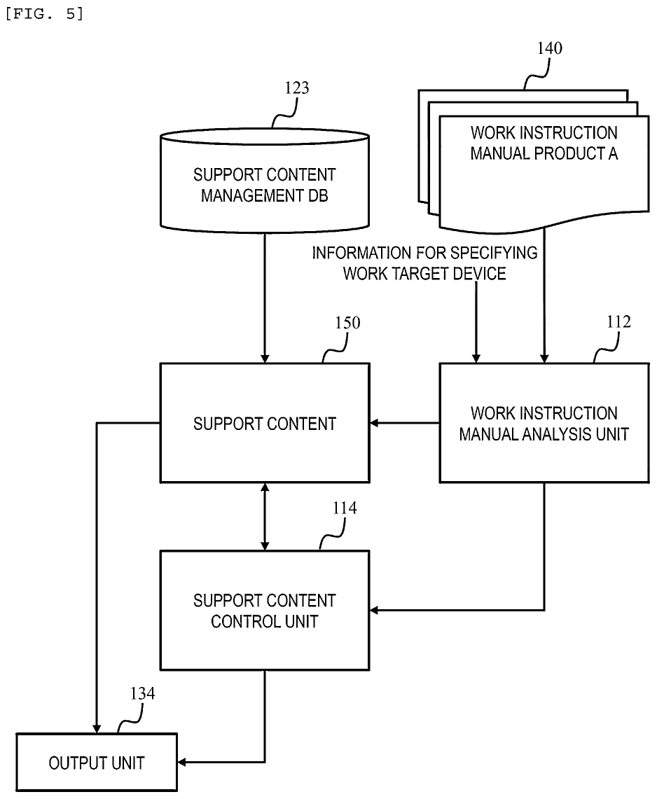

An example of a method of generating the support content 150 based on the work instruction manual 140 will be described with reference to FIG. 5. The work instruction manual 140 is prepared for each type of the target device 4, and a procedure of the maintenance work of the target device 4 is described. The work instruction manual 140 may include text data and still image data, or at least a part thereof may include moving image data or voice data.

When the information for specifying the target device 4 is input, the work instruction manual analysis unit 112 acquires the work instruction manual 140 of the specified target device 4 from the work instruction manual management database 122. The information for specifying the target device 4 may be manually input by either the worker U1 or the work supporter U2, and the information for specifying the target device 4 that may be automatically received from a maintenance plan management system (not shown) or the like includes, for example, a model type, a model name, and a serial number. When the worker U1 manually inputs the information for specifying the target device 4, the work supporter U2 who supervises the worker U1 may inspect whether the input information for specifying the target device 4 is correct.

The work instruction manual analysis unit 112 acquires the support content 150 corresponding to the target device 4 from the support content management database 123 based on the information for specifying the target device 4. The work instruction manual analysis unit 112 may generate the support content 150 based on the information for specifying the target device 4.

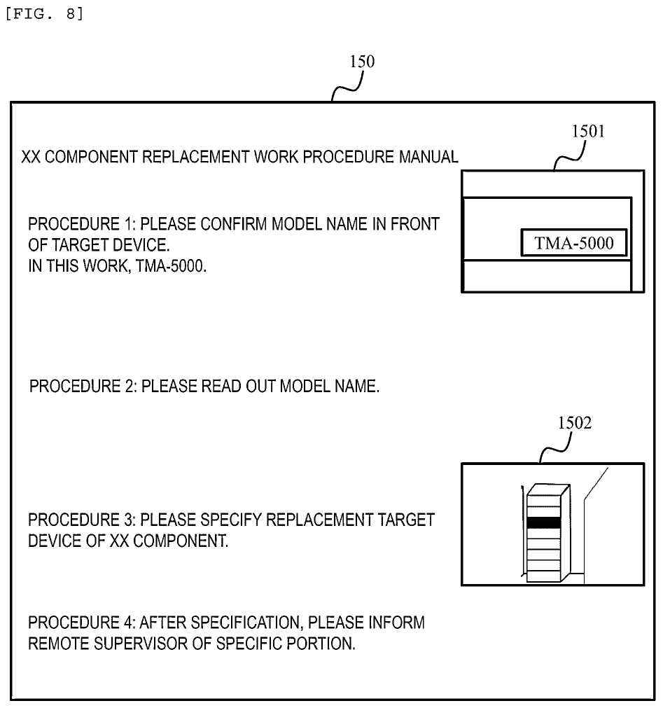

The generated support content 150 is output to the output unit 134. The support content control unit 114 controls a display content of the support content 150. An example of the support content 150 will be described later with reference to FIG. 8.

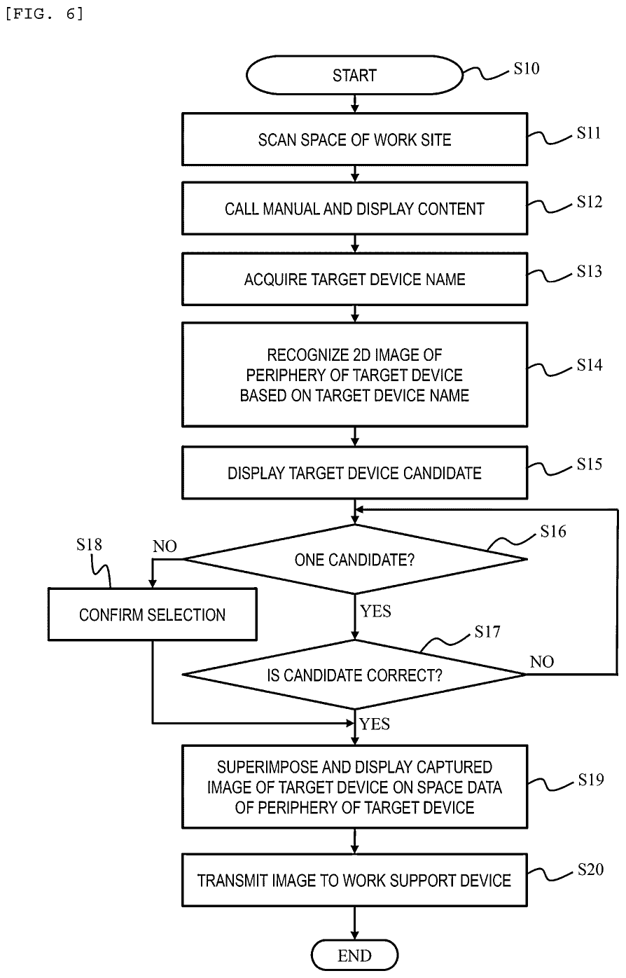

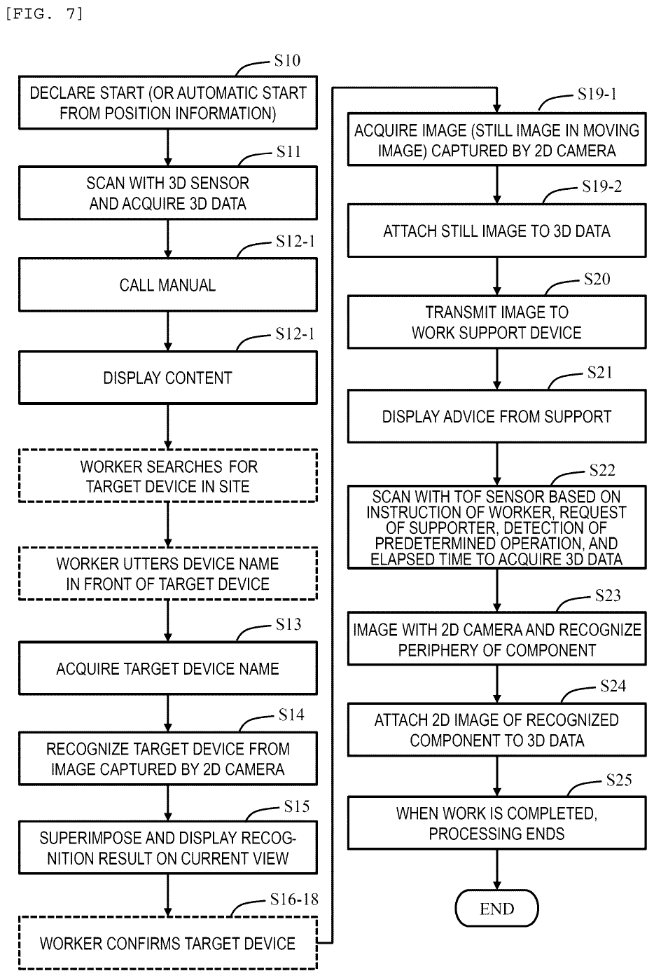

Processing of specifying a work target will be described with reference to flows of FIGS. 6 and 7. In the flow of FIG. 6, a method, in which the worker U1 specifies the work target device 4 while confirming the work instruction in the work site WS, will be described. FIG. 6 is a flow showing the operation of the work target specifying device 1, and FIG. 7 is an overall flow of work support processing. In FIG. 7, the operation of the worker U1 is indicated by dotted line blocks.

When work target specifying processing is started (S10), first, the space grasping unit 111 acquires point group data on the periphery of the worker U1 by the 3D sensor 132, and creates space data on the periphery (S11). When the worker U1 instructs the start of the processing from the input unit 133, the processing is started. When the work target specifying device 1 can use a position sensor such as a GPS, the processing may be automatically started when the work target specifying device 1 arrives at a predetermined place.

The work instruction manual analysis unit 112 acquires the work instruction manual 140 stored in the work instruction manual management database 122 (S12-1 in FIG. 7), and the support content control unit 114 displays the work instruction content 150 on the output unit 134 (S12-2). Step S12 in FIG. 6 can be divided into step S12-1 and step S12-2 shown in FIG. 7.

FIG. 8 shows an example of the content 150 that supports work. Here, a procedure of specifying the target device 4 for performing component replacement work is described. Although not shown in FIG. 8, when the specification of the target device 4 is completed, an instruction for a series of work, such as taking out of the target device 4, disassembling of the target device 4, and replacement of a predetermined component, is displayed in the support content 150.

The work instruction manual analysis unit 112 instructs the worker U1 to confirm the model name in front of the target device 4 (procedure 1). In this example, the model name of the target device 4 is “TMA-5000”. The model name is not necessarily displayed on the front surface of the target device 4. The model name may be displayed on a side surface, a rear surface, a bottom surface, or an upper surface of the target device 4. Accordingly, there is a possibility that the target device 4 cannot be found only by viewing the inside of the work site WS by the 2D camera 131 and capturing an image. Here, in the embodiment, an action of the worker U1 is guided such that the worker U1 moves to the front of the device considered to be the target device 4. The support content 150 displays the model name of the target device 4 (1501).

When the worker U1 arrives in front of the device considered to be the target device 4, the worker U1 reads out the model name (procedure 2). The work instruction manual analysis unit 112 acquires the model name read by the worker U1 via a microphone provided in the input unit 133, converts the acquired voice data into a text, and stores the text (S13).

In the embodiment, it is determined that the worker U1 has found the target device 4 by reading out specifying information (model name, model type name, device number, or the like) of the device in front of the worker U1 using the microphone of the input unit 133. Instead of this, the target device 4 in front of the worker U1 is imaged by the 2D camera 131, and the specifying information included in the imaging result is subjected to character recognition, so that it is determined that the worker U1 has found the target device 4 and is in front of the target device 4. Accordingly, since it is possible to prevent the worker U1 from reading mistake, it is possible to detect the finding of the target device 4 more smoothly and accurately.

The continuation of the flow will be described. The work instruction manual analysis unit 112 activates the object recognition unit 113 to recognize a device corresponding to “TMA-5000” (S14). Specifically, a subject (an object considered to be the target device 4) in front of the worker U1 is imaged by the 2D camera 131, and the captured two-dimensional image data is subjected to recognition processing by the object recognition unit 113.

The object recognition unit 113 superimposes and displays the object recognition result on the output unit 134 (S15). When the work target specifying device 1 is a tablet, the worker U1 directs the tablet to the target device 4 by augmented reality (AR) to display a device candidate on the target device viewed on the screen of the tablet.

When the work target specifying device 1 is a head mounted display (HMD), candidates of the target device 4 are superimposed and displayed, by AR or mixed reality (MR), on a landscape viewed by the worker U1 (S15). When there is one object recognition result (S16: YES), the processing proceeds to S17.

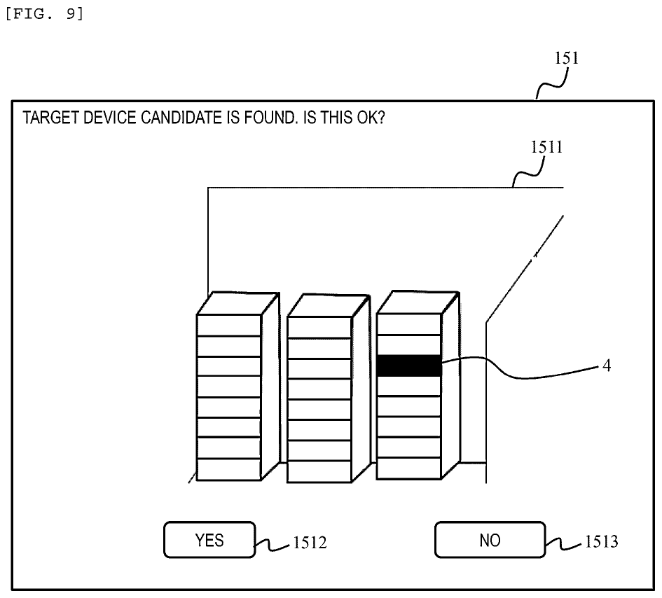

FIG. 9 is a confirmation screen 151 showing a result of recognizing the candidates of the target device 4. A periphery configuration 1511 of the target device 4 is also displayed on the screen 151. When the worker U1 confirms the object recognition result, a “YES” button 1512 is selected (S17: YES). In contrast, when a “NO” button 1513 is selected by the worker U1 (S17: NO), the processing returns to step S16.

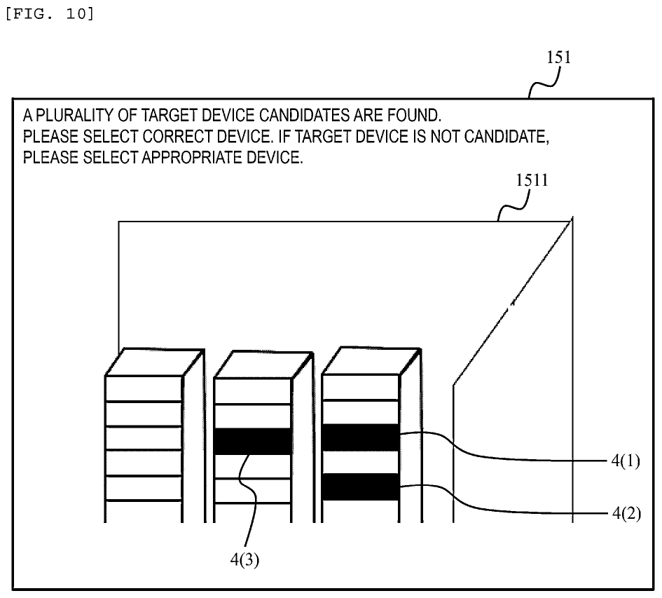

When there are a plurality of object recognition results (S16: NO), the work instruction manual analysis unit 112 causes the worker U1 to select which is the correct target device 4 (S18). FIG. 10 is a screen for confirming one device among a plurality of candidates 4(1) to 4(3) of the target device.

In FIG. 10, the candidates 4(1) to 4(3) of the target device recognized from the image captured by the 2D camera 131 are displayed. The worker U1 designates one candidate considered to be appropriate from the candidates 4(1) to 4(3) through the input unit 133 (S18).

When the work target specifying device 1 is a tablet, the worker U1 touches a candidate considered to be appropriate on the touch panel. When the work target specifying device 1 is the HMD, the worker U1 selects a candidate considered to be appropriate by moving the line of sight or moving the hand or the finger.

The portion determination unit 115 associates the three-dimensional space data acquired in step S11 with the information of the target device 4 selected in step S17 or step S18, images the periphery including the target device 4 by the 2D camera 131, and attaches the captured two-dimensional image data to the three-dimensional space data acquired in step S11 (S19).

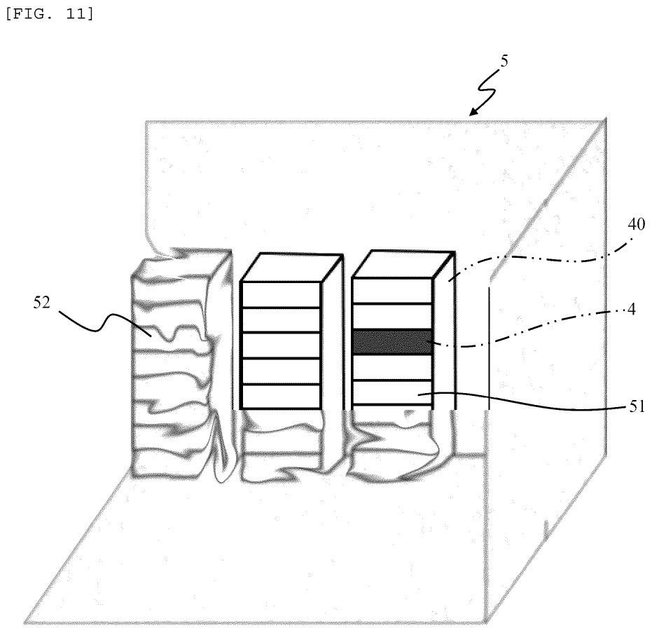

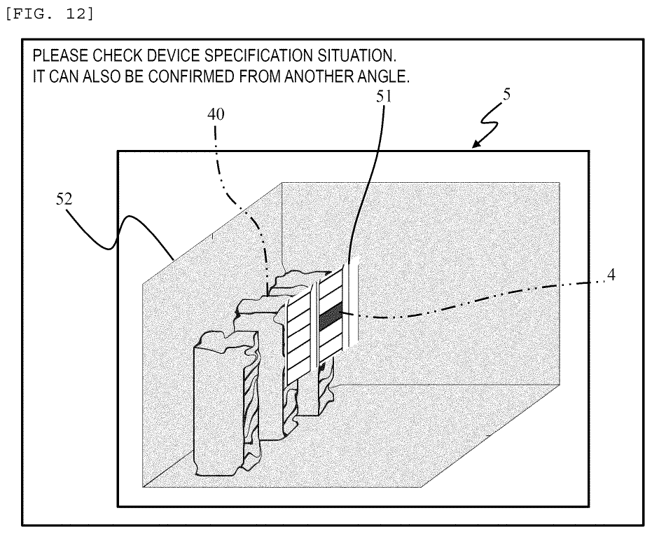

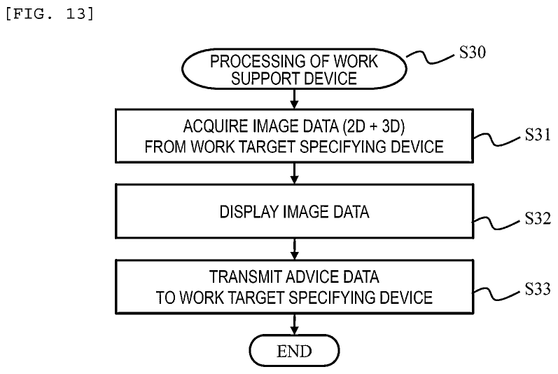

FIG. 11 is an example in which the two-dimensional image data 51 of the periphery of the selected target device 4 is attached to the three-dimensional space data 52. FIG. 11 is used in the flow of FIG. 13. Here, the attachment of the two-dimensional image data to the three-dimensional space data means that the two-dimensional image data is displayed at a predetermined position in the three-dimensional space data 52. FIG. 12 is a diagram showing a state in which the work supporter U2 operates predetermined image data (image data obtained by composing the two-dimensional image data and the three-dimensional space data) in the work support device 2. The operation means rotating the image to change the direction. FIGS. 11 and 12 will be further described later.

When the three-dimensional space data 52 is acquired by the 3D sensor 132 such as ToF sensor or a stereo camera, the three-dimensional space data 52 is acquired by connecting a plurality of pieces of image data captured by the 3D sensor 132. Therefore, the three-dimensional space data 52 is generally unclear due to shaking or chipping as shown in FIG. 11, for example, by camera shake during measurement and fluctuation of a value of the ToF sensor. Accordingly, only by the three-dimensional space data 52, the work supporter U2 as the skilled worker may be difficult to accurately determine a position where the work target device 4 is located.

Therefore, in the embodiment, the two-dimensional image data 51 captured by the 2D camera 131 is superimposed and displayed on the three-dimensional space data 52. Accordingly, the work supporter U2 can clearly confirm a position in the work site WS where the target device 4 is located.

The work target specifying device 1 transmits, to the work support device 2, the predetermined image data (also referred to as the composite image data) in which the two-dimensional image data 51 is superimposed on the three-dimensional space data 52 (S20). When the composite image data is acquired, the work support device 2 causes the output unit 232 to display the composite image data. The work supporter U2 can view the composite image data, and visually confirm that the worker U1 arrives at the correct target device 4 and is to start the work. Then, the work supporter U2 can give advice for supporting the work to the worker U1 in the work site WS via the microphone provided in the input unit 231.

Processing in which the work supporter U2 confirms, based on the composite image data, the target device 4 specified by the worker U1 will be described with reference to FIG. 13. The processing is started, for example, when the work supporter U2 activates the work support device 2. Alternatively, the processing may be automatically started when data is received from the work target specifying device 1.

The space grasping unit 211 of the work support device 2 acquires the composite image data received from the work target specifying device 1 via the communication unit 234 (S31). The composite image data received from the work target specifying device 1 via the communication unit 234 is stored in the space information management database 221.

The work target specifying unit 212 displays the screen 5 for confirming the work place based on the acquired composite image data (S32). FIGS. 11 and 12 are examples of screens displayed on the output unit 232 of the work support device 2.

The screen 5 can be rotated at any angle in a plurality of directions of, for example, yaw, pitch, and roll, through an operation input from the input unit 231. Further, the image 5 can be enlarged or reduced in front-rear and left-right directions. Operation buttons for rotation, enlargement and reduction, or the like may be displayed on the screen 5 so as to be operated using a touch panel, a keyboard, a mouse, or the like.

In FIG. 11, the two-dimensional image data having a high resolution is superimposed and displayed on the periphery of the work target device 4 designated by the worker U1. In the two-dimensional image data 51 having a resolution, a portion corresponding to the work target device 4 is color-coded so as to be distinguished from other devices. The work supporter U2 can easily confirm a positional relationship including the depth or the like by displaying the image 5 at any position and angle.

FIG. 12 shows an example in which the device or the like shown in FIG. 11 is rotated by 90 degrees in a direction perpendicular to a ground surface. The work supporter U2 can confirm a positional relationship in the periphery configuration 40 of the target device 4 from an angle other than the front surface captured by the 2D camera 131.

According to the work support system 7 of the embodiment configured as described above, it is not necessary to acquire the three-dimensional space data of the work site WS in advance before the work to create a map of the three-dimensional space. Since the three-dimensional space data is acquired in a necessary range each time the work is performed, the work support system 7 is easy to use. Further, the work support system 7 according to the embodiment can cope with a case where work is performed in a new work site WS and a case where a part of the existing work site WS is changed.

That is, the work support system 7 according to the embodiment can three-dimensionally map the two-dimensional image data including the target device 4 to the three-dimensional space data even if an arrangement of devices or objects placed on the work site WS is dynamically changed. Accordingly, since the worker U1 and the work supporter U2 share the three-dimensional mapping result, the work supporter U2 can intuitively understand the device for which the worker U1 is to start the work or the device for which the worker U1 is performing the work. Accordingly, the work supporter U2 can confirm whether the device selected by the worker U1 is a correct device, and can provide the worker U1 with advice or the like related to the work for the target device 4 through the work target specifying device 1.

### Second Embodiment

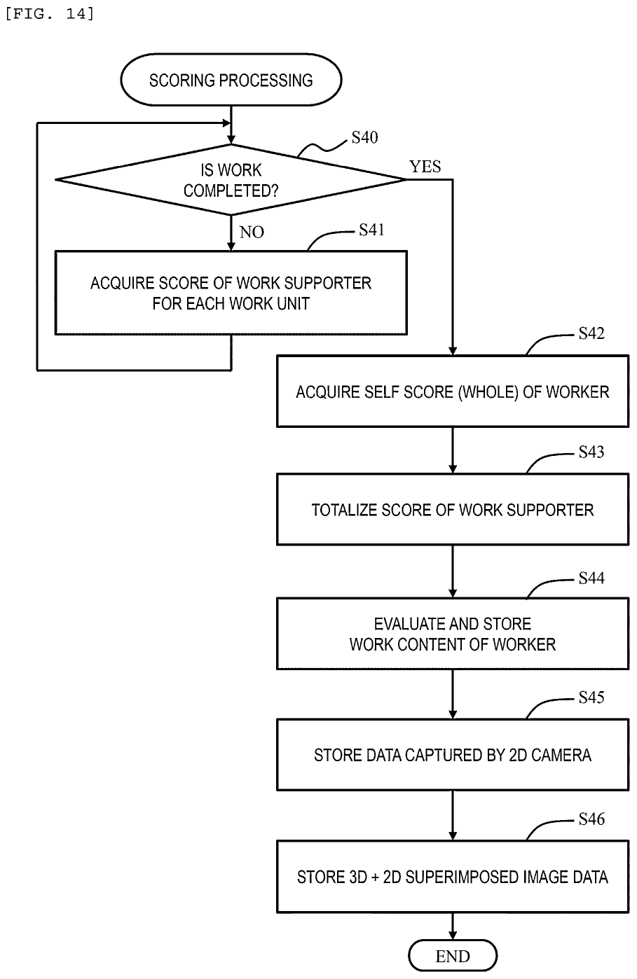

A second embodiment will be described with reference to FIG. 14. Since the following embodiments including the embodiment correspond to modifications of the first embodiment, differences from the first embodiment will be mainly described. A work support system according to the embodiment evaluates and stores work performed by the worker U1.

FIG. 14 shows a flow of scoring processing. The processing can be executed by any of the work target specifying device 1, the work support device 2, and the work support management device 3. In addition, a scoring result in the work target specifying device 1 and a scoring result in the work support device 2 may be managed by the work support management device 3. Here, it is assumed that the work target specifying device 1 executes the scoring processing.

The work target specifying device 1 determines whether the work performed by the worker U1 is completed (S40). When the work is not completed (S40: NO), a score obtained from the work supporter U2 is acquired and stored for each work unit of the worker U1 (S41). That is, the work supporter U2 scores the work of the worker U1 for each work unit, such as the worker U1 taking out the target device 4 from the rack, removing a top plate of the target device 4, and replacing the components in the target device 4, and inputs the scoring result to the input unit 231. The received scoring result is transmitted to and stored in the work target specifying device 1 (S41). The completion of the work can be detected by the worker U1 inputting, to the input unit 133, information indicating the completion of the work. The worker U1 may operate a work completion button (not shown) on the screen output by the output unit 134, or may input the work completion by voice or a text such as “fan replacement work of product A is completed”.

When the work performed by the worker U1 is completed (S40: YES), the work target specifying device 1 acquires a self score of the worker U1 (S42). The self scoring is performed for the entire work of the worker U1. Instead of this, the worker U1 may perform the self scoring for each work unit during the work or after the work. For example, the worker U1 may input, to the input unit 133, a result of the self scoring for each work unit, such as “removal of the device 4 is completed. 100 points” and “fan replacement work is completed. 90 points”.

The work target specifying device 1 totalizes the score obtained from the work supporter U2 and the self score of the worker U1 (S43). The work target specifying device 1 evaluates the work of the worker U1 based on score totalization, and stores the work in the auxiliary storage unit 120 (S44). The work target specifying device 1 stores the image data captured by the 2D camera 131 during the work in the auxiliary storage unit 120 (S45), and also stores the composite image data in the auxiliary storage unit 120 (S46).

The work target specifying device 1 can evaluate the work of the worker U1 by, for example, ranking or scoring based on a totalization result of the score obtained from the work supporter U2 and the self score of the worker U1. The evaluation result, the two-dimensional image data obtained by imaging at least a part of the work in the work site WS, and the composite image data are associated with one another, and are recorded in a work history management database (not shown). The work history management database may be provided in the work instruction manual management database 122.

The embodiment configured as described above also exhibits the same effects as those of the first embodiment. Further, according to the embodiment, since the work content of the worker U1 can be scored and stored as a history, the work content can be used for work evaluation or the like of the worker U1, and can also be used for improvement of the work instruction manual 140. For example, when there are work items with low evaluation for many workers U1, it can be determined that there is room for improvement in the design of the target device 4 or there is room for improvement in the description of the work instruction manual 140.

### Third Embodiment

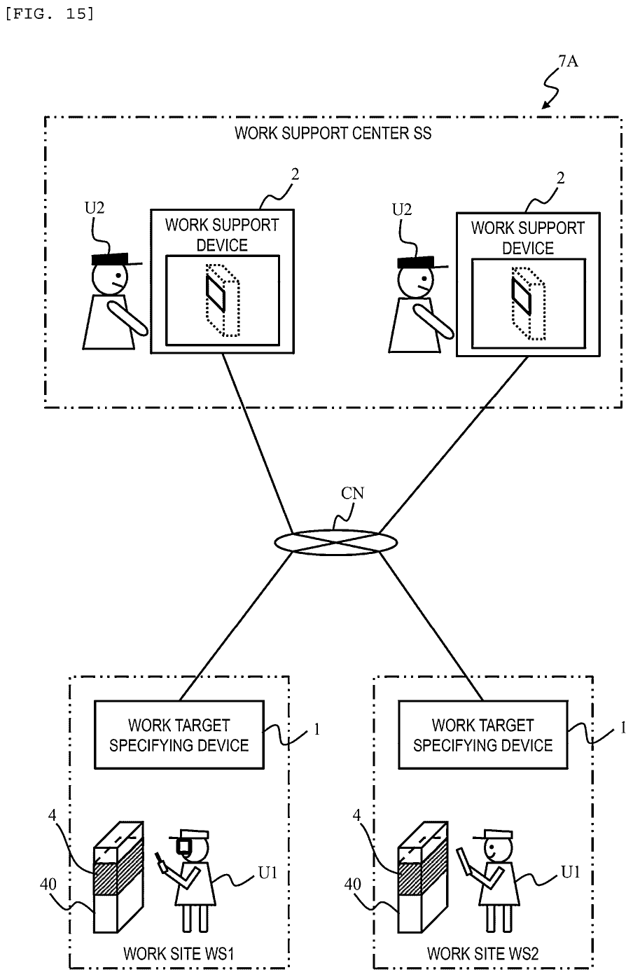

A third embodiment will be described with reference to FIG. 15. In a work support system 7A according to the embodiment, the work target specifying device 1 and the work support device 2 are directly connected to each other, and the work support management device 3 is not provided. The embodiment configured as described above also exhibits the same effects as those of the first embodiment.

The invention is not limited to the above-described embodiments. Those skilled in the art can perform various additions, modifications, or the like within the scope of the invention. The above-described embodiments are not limited to the configuration example shown in the accompanying drawings. The configurations and the processing methods of the embodiments can be appropriately changed within the scope to achieve the object of the invention.

In addition, components of the invention can be freely selected, and an invention including the selected components is also included in the invention. Further, the configurations described in the claims can also be combined in addition to the combinations described in the claims.

### REFERENCE SIGNS LIST

1: work target specifying device
2: work support device
3: work support management device
4: work target device
5: image displayed by work support device
7: work support system
111: space grasping unit
112: work instruction manual analysis unit
113: object recognition unit
114: support content control unit
115: portion determination unit
131: 2D camera
132: 3D sensor
133: input unit
133: output unit
211: space grasping unit
212: work target specifying unit

1. A work support system for supporting work of a worker, the work support system comprising:
a work target specifying device to be used by the worker; and
a work support device to be used by a work supporter for supporting the work of the worker, the work support device being communicably connected to the work target specifying device, wherein
the work target specifying device is configured to acquire three-dimensional space data of a work space including a target device, create predetermined image data by associating two-dimensional image data obtained by imaging the target device with the target device in the three-dimensional space data, and output the created predetermined image data to the work support device, and
the work support device is configured to display the predetermined image data received from the work target specifying device, and transmit information received from the work supporter to the work target specifying device.

2. The work support system according to claim 1, wherein
the work target specifying device is configured to create support content data including guidance information for guiding the worker to the target device in the work space and provide the support content data to the worker.

3. The work support system according to claim 2, wherein
the guidance information is information for requesting the worker to input, to the work target specifying device, specifying information for specifying the target device, in front of the target device.

4. The work support system according to claim 2, wherein
the support content data is created based on work instruction manual data describing a work instruction for the target device.

5. The work support system according to claim 1, wherein
the work target specifying device is configured to extract a candidate of the target device by analyzing the two-dimensional image data obtained by imaging the work space, and present the candidate to the worker.

6. The work support system according to claim 5, wherein
when a plurality of candidates of the target device are provided, the work target specifying device causes the worker to select the target device from the plurality of candidates of the target device presented to the worker.

7. The work support system according to claim 1, wherein
the work target specifying device is configured to acquire an evaluation of the work for the target device and store the evaluation together with a work history.

8. The work support system according to claim 1, wherein
the work target specifying device and the work support device are directly connected to each other.

9. A work target specifying device for specifying a work target device, wherein
three-dimensional space data of a work space including a target device is acquired from a three-dimensional space data acquisition unit,
two-dimensional image data of the target device is acquired from a two-dimensional image data acquisition unit,
predetermined image data is created by associating the two-dimensional image data of the target device with the target device in the three-dimensional space data,
the created predetermined image data is transmitted to a work support device, and
support information based on the predetermined image data is received from the work support device.

10. A work target specifying method for specifying a work target device, the work target specifying method comprising:
acquiring, from a three-dimensional space data acquisition unit, three-dimensional space data of a work space including a target device;
acquiring, from a two-dimensional image data acquisition unit, two-dimensional image data of the target device;
creating predetermined image data by associating the two-dimensional image data of the target device with the target device in the three-dimensional space data;
transmitting the created predetermined image data to a work support device; and
receiving, from the work support device, support information based on the predetermined image data.
